(19) United States
(12) Patent Application Publication
(10) Pub. No.: US 2007/0189004 A1
(43) Pub. Date: Aug. 16, 2007

(54) Illum-A-Field Modification of Medical and Surgical Instruments

(76) Inventors: Guy Dickes, Baltimore, MD (US); Howard J. Leventhal, Baltimore, MD (US)

Correspondence Address: GUY DICKES, 6718 CHOKSBERRY RD., BALTIMORE, MD, 21209, US

(21) Appl. No.: 11/563,237

(22) Filed: Nov. 27, 2006

Related U.S. Application Data
(60) Provisional application No. 60/597,963, filed on Dec. 28, 2005.

(51) Int. Cl. F21V 33/00

(52) U.S. Cl. 362/109; 362/800

(57) ABSTRACT

ILLUM-A-FIELD^{R} Modification of Medical and Laboratory Instruments encompasses attaching a LED Assembly to medical, laboratory and other instruments and tools. Power to said assembly is a portable, lightweight, rechargeable power supply. Major advantages include field portability; use in hostile environments including battlefield conditions and civilian emergency situations; can be supplied with extremely long shelf-life batteries; can be used as emergency lighting due to the light output of the device. It has been shown to effectively reduce working time in histology and pathology laboratories. ILLUM-A-FIELD^{R}'s ability to work submerged makes this a substantial improvement of medical instruments used in burn centers where patients must remain under water and other applications where a submersible implement would be of benefit.

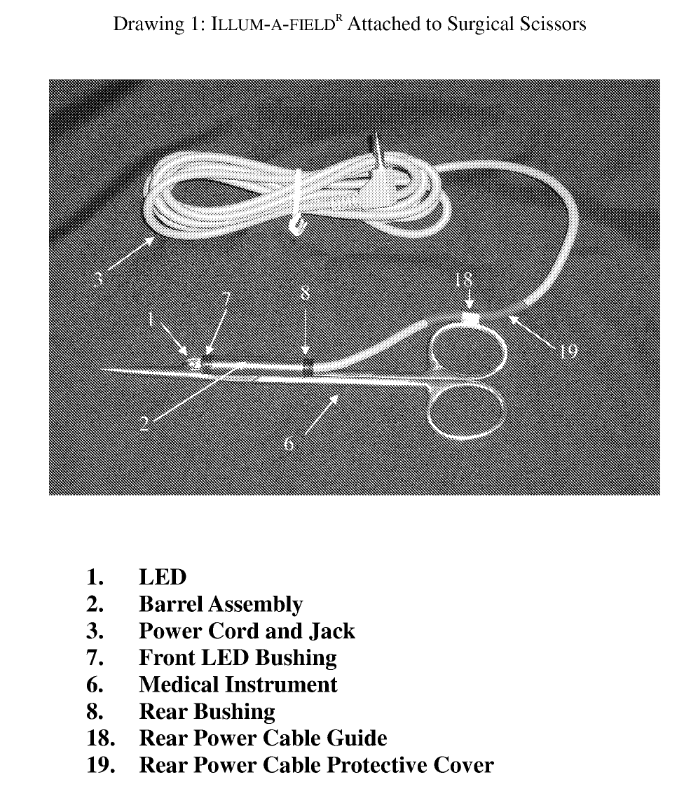

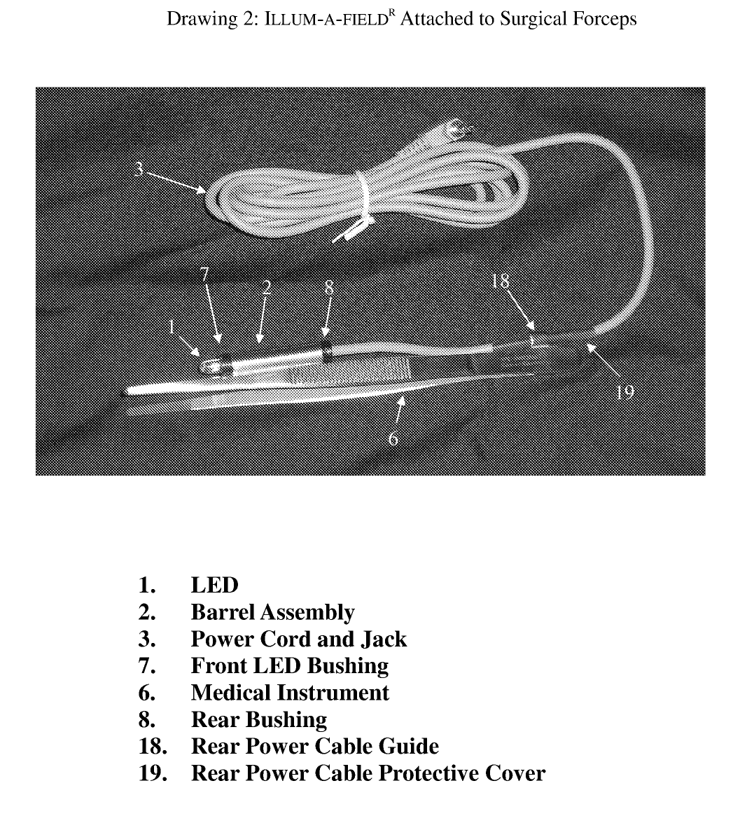

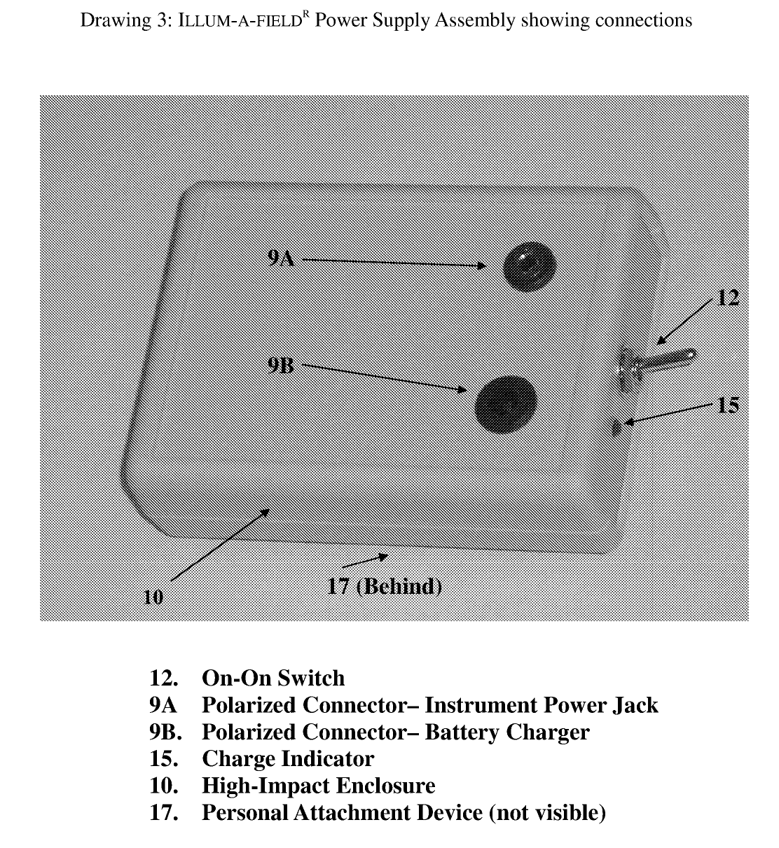

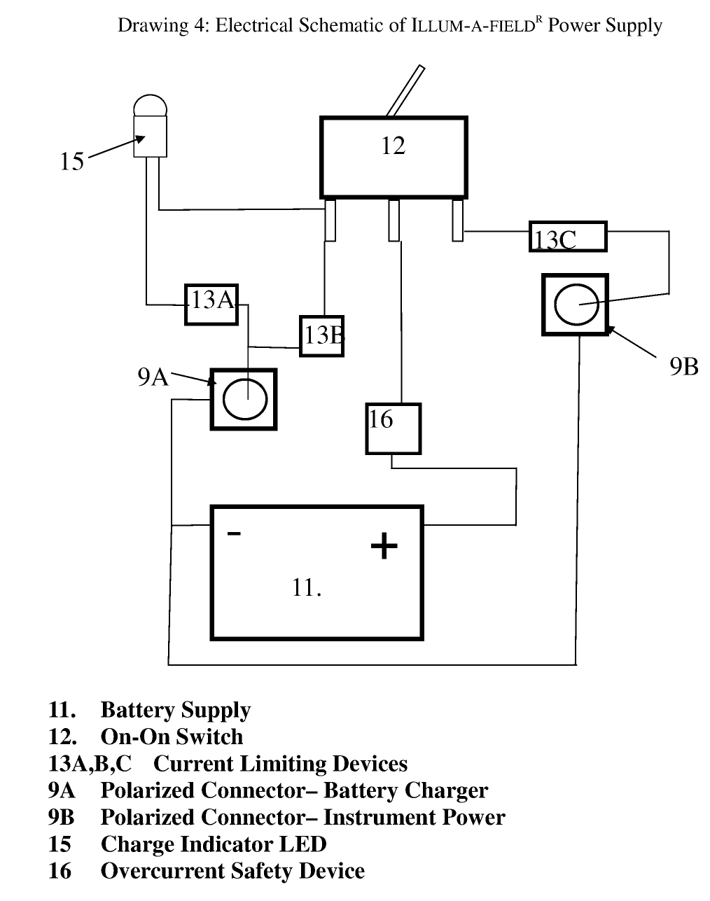

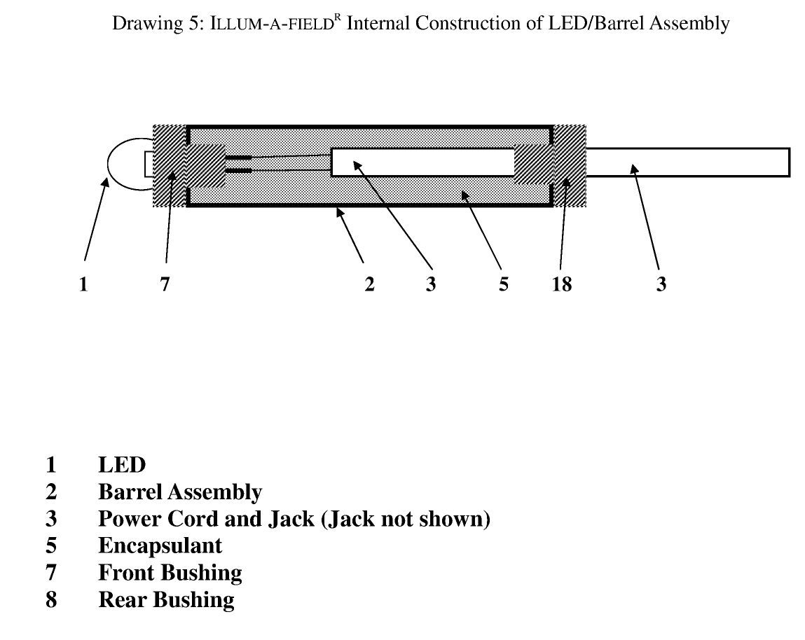

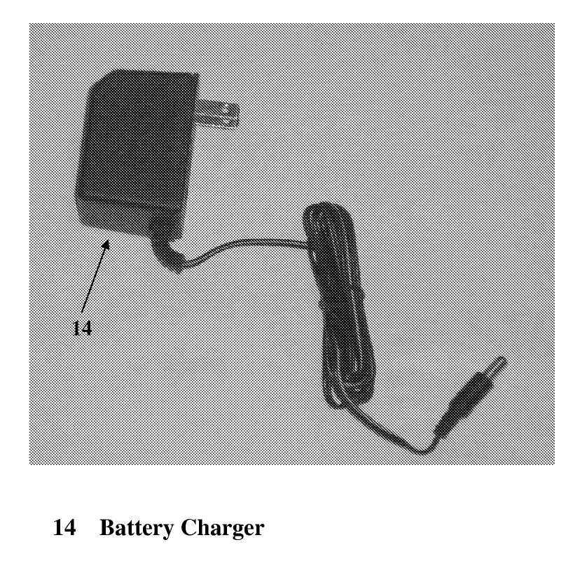

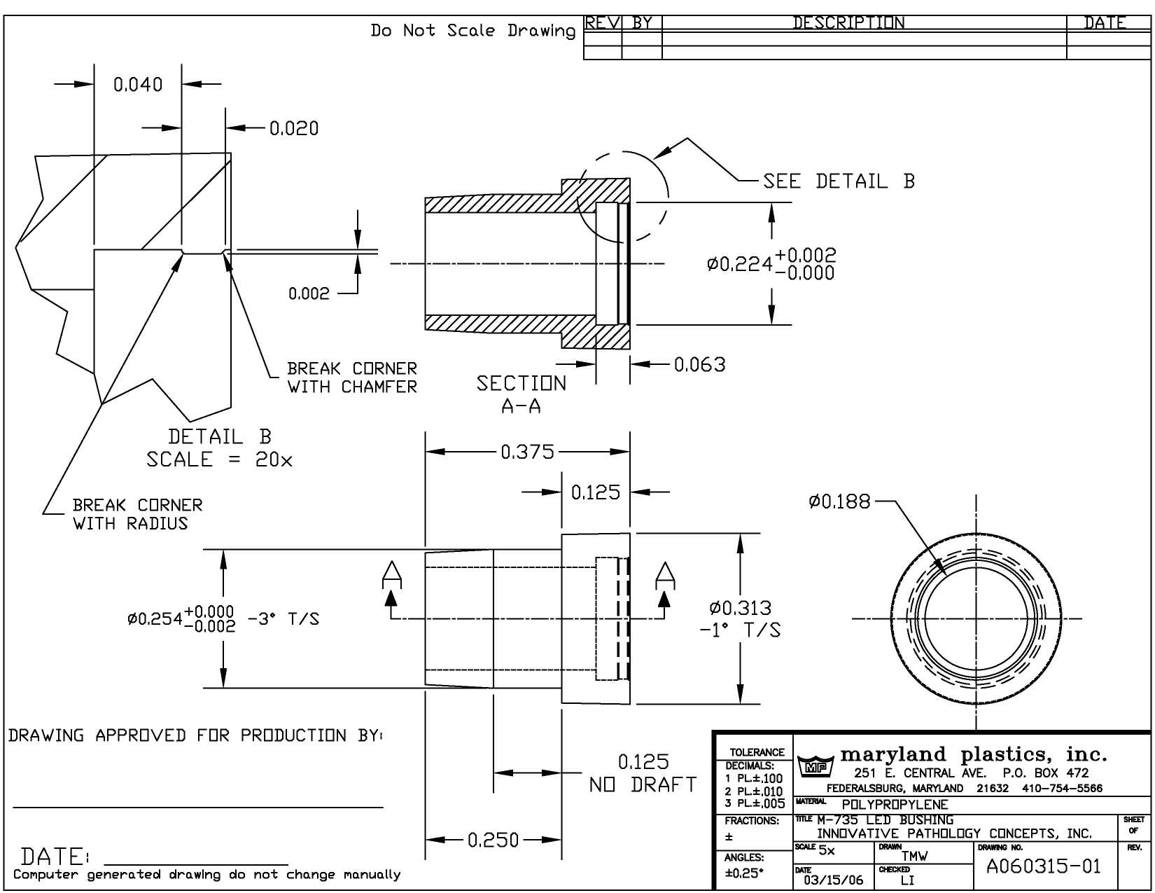

PRIOR PROVISIONAL APPLICATION No. 60/597963 Filed Dec. 28, 2005

### CROSS REFERENCE TO RELATED APPLICATIONS

| Patent Document No. | Inventor |
|---|---|
| 6,129,662 | Li et al. |
| U.S. Pat. No. 6,428,180 B1 | Karram et al. |
| U.S. Pat. No. 6,607,384 B1 | Nakanishi |
| U.S. Pat. No. 6,648,902 B2 | Colgan et al. |
| U.S. Pat. No. 6,786,628 B2 | Steen et al. |
| U.S. Pat. No. 6,830,547 B2 | Weiss |
| U.S. Pat. No. 6,877,242 B2 | Mackin et al. |

| Foreign Patent Document Number | Country and Date |
|---|---|
| 0 190 014 A2 | Europe, August 1986 |

Internet Documents

“LED Portable Lamps”

http://www.tecnocem.com/LED-lights-work.htm, three pages

“Surgical Lighting”

http://www.medical-lighting.com/surgery.html, two pages

ILLUM-A-FIELD^{R} Modification of Medical and Laboratory Instruments (herein referred to as ILLUM-A-FIELD^{R}) originated in response to Mr. Leventhal's needs in anatomic pathology in a local Baltimore, Md. hospital. During the performance of post-mortem examinations and various surgical pathology procedures, Mr. Leventhal found it difficult to have sufficient light within a body cavity, and at certain points of tissue dissection.

A discussion between Mr. Leventhal and Mr. Dickes produced the first working prototype of the trade-marked name ‘ILLUM-A-FIELD^{R}’ Modification of Medical and Laboratory Instruments in July 2005. A company was formed to produce and market said modified medical instruments at that time.

ILLUM-A-FIELD^{R} takes standard and custom manufactured medical instruments and permanently or temporarily affixes a high-powered, focused Light Emitting Diode (henceforth LED) light assembly near the working area of each instrument. Power to the LED for general medical and commercial use is supplied by an external rechargeable battery pack contained within the Power Supply Assembly. Internal components of the Power Supply Assembly include current limiting devices for both the charging and lighting circuit, designed for the capacities of the battery source and the LED. Military versions use long shelf life batteries to provide service personnel with an instrument capable of use even after extremely long storage times. Typical useful working time of the illuminating device is 24 hours continuous use between charging or much longer periods of time when used intermittently.

Additional uses include police/fire rescue/emergency/military medical services. Scissors as well as other medical instruments adapted with ILLUM-A-FIELD^{R} permit working in low/no light situations where focused light is necessary to perform immediate life-saving measures in the field without drawing attention from hostile forces.

### BRIEF DESCRIPTION OF THE SEVERAL VIEWS OF THE DRAWING

The drawings attached reflect a partial list of the versions of ILLUM-A-FIELD^{R} Modification of Medical and Laboratory Instruments

Drawing 1: ILLUM-A-FIELD^{R} Attached to Surgical Scissors

Drawing 2: ILLUM-A-FIELD^{R} attached to Surgical Forceps (tweezers)

Drawing 3: Power Supply Assembly showing connections

Drawing 4: Electrical Schematic of ILLUM-A-FIELD^{R} Power Supply

Drawing 5: Internal Construction of LED/Barrel Assembly

Drawing 6: External Charger

Drawing 7: M-735 LED Bushing (technical shop drawing of Front LED Bushing)

ILLUM-A-FIELD^{R} incorporates LED technology with standard medical and laboratory instruments and other types of implements to increase the usefulness of said instruments. The ILLUM-A-FIELD^{R} technology is comprised of a high output narrow focus Light Emitting Diode, henceforth called LED(1); housed in Barrel Assembly(2) which is permanently or temporarily affixed to said medical instrument(s) (6) and is focused towards the work area; Power Cord and Jack(3) to provide controlled electric power to the LED(1) from the Power Supply Assembly(4).

Within the Barrel Assembly(2) the Power Cord and Jack(3) are fused with the electrical connections of said LED(1). Also contained within the Barrel Assembly (2) are an Electrical Encapsulant(5), Front LED Bushing(7) and Rear Bushing (8) providing permanent sealing against moisture and contamination of the LED(1) within the Barrel Assembly(2). The Power Cord and Jack(3) are constructed monolithically to maintain permanent sealing from moisture and contamination from entering said assembly. The Power Cord(3) is round coaxial cable, rather than flat cable, to allow for optimal cleaning and minimized adhesion of contaminants.

The Power Supply Assembly(4) contained within the High Impact Enclosure(10) containing the following:
High capacity voltage supply (herein called Battery Supply(11) to provide power through Current Limiting Device (13C) to LED(1)
On-On Switch(12) to control power to LED(1) and Battery Charger(14) from Battery Supply(11)
Current Limiting Devices (13A, 13B, 13C) to control power to LED(1); battery supply(11) charging circuit and to Charge Indicator LED(15)
Overcurrent Safety Device (Fuse)(16) to protect circuitry from unanticipated electrical short
Personal Attachment Device(17) to provide a mechanical means to easily attach and remove the Power Supply Assembly(4) to the individual User.
Polarized Connectors(9A,B) of different dimensions for Charger(14) and Power Cord(3)

The LED used is a 5 millimeter electronic device producing 18,600 micro candle (mcd) power and focused to a 15 degree pattern, providing high intensity nearly pure white light into the work area of the said medical (or other) instrument (6). The Barrel Assembly(2) is either permanently or temporarily attached to said instrument(6) to focus said light into the work area and prevent accidental loss of Barrel Assembly(2) into the work area.

The Power Supply Assembly(4) is typically configured to provide power to the LED(1) for over 24 hours of continuous use and can be recharged several hundred times. This will provide the User with a productive device for many years.

The Power Supply Assembly, when provided with an ultra-long shelf life battery (i.e. rechargeable/non-rechargeable lithium-ion batteries,) will allow for the device to be kept on a ready-to-use basis for many years without maintenance or compromise of capability. Additionally the Battery Supply(11) can be changed both in voltage, capacity and construction to the individual user's requirements.

Typical medical instruments would include, but not limited to, forceps, scissors, scalpels, hemostats.

Major Parts, Description and Usage:
1. Light Emitting Diode (LED) solid state electronic device—provides focused light on work area
2. Barrel Assembly—typically stainless steel—provides enclosure for LED(1) and connection area for Power Cord and Jack(3); is attached to Medical Instrument (6)
3. Power Cord and Jack—supplies power to LED(1) and connection to Power Supply Assembly(4) through Polarized Connector(9B)
4. Power Supply Assembly—supplies power to LED(1) through Power Cord and Jack(3), and current limiting devices(13C)
5. Encapsulant—seals LED(1), connections within Barrel Assembly(2) and Power Cord and Jack(3) from external contamination and moisture within Barrel Assembly(2) with a chemically and electrically resistant compound
6. Medical Instrument—device used by personnel and to which the Barrel Assembly(2) is permanently attached
7. LED Bushing—a specially designed plastic assembly to hold the LED in the correct alignment, provide a forward seal against moisture or foreign material intrusion. The LED is snap-locked into correct position
8. Rear Bushing provides for sealing the rear of the Barrel Assembly(2) and the Power Cord and Jack(3)
9A, B. Polarized Connectors—for connecting Power Cord and Jack(3) and Charger(14) to components of the Power Supply Assembly(4)
10. High Impact Enclosure—houses all parts of the Power Supply Assembly(4)
11. Battery Supply—provides rechargeable power source for LED(1)
12. On-On Switch—controls power distribution to from Battery Supply (11) to Battery Charger (14) or to LED(1)
13 A,B,C, Current Limiting Devices—13C controls the amount of power distributed to LED(1); 13A to the Charger Indicator LED(15) and 13B to the Battery Supply(11)
14. Battery Charger—commercially available wall charger energizes Battery through Current Limiting Device(13B) and Polarized Connector (9A)
15. Charge Indicator LED—indicates when Battery Charger(14) is supplying recharge electric power to Battery Supply(11)
16. Overcurrent Safety Device (fuse)—provides protection from overcurrent to internal and external components of the entire system
17. Personal Attachment Device—permits connection of Power Supply Assembly (4) housed within High-impact Enclosure(10) to User
18. Rear Power Cord Guide—a permanently affixed tube to guide Power Cord and Jack (3) from entanglement of the User's hand
19. Rear Power Cord Protective Covering—a secondary protective cover of the Power Cord and Jack (3) to extend the useful life of the instrument

What is claimed is:

1. A device for providing high-intensity focused light source at the working end of a tool or instrument.

2. An assembly for holding said components in the correct alignment to direct the light source.

3. An LED assembly, within a metallic barrel, capable of working submerged in water or other liquids.

4. A power pack assembly to provide electrical current, properly conditioned for the LED.

5. A custom designed plastic bushing to hold the LED in the correct alignment and fit into the metallic barrel. Said bushing provides a ‘snap-fit’ lock around the LED.

6. A custom designed plastic bushing to seal the rear of the barrel and centralize the Power Cord Assembly as it exits the rear of the Barrel.

7. The entire assembly may be sterilized in accordance with accepted cold sterilization processes.

8. The entire implement can be submerged to allow underwater use.
